(19) United States
(12) Patent Application Publication
(10) Pub. No.: US 2007/0260402 A1
(43) Pub. Date: Nov. 8, 2007

(54) DESTINATION SPA INFUSED WITH EXPERIENTIAL LIFE MANAGEMENT ON GOVERNMENT OWNED LAND

(76) Inventors: H. Elizabeth TARAS, Belchertown, MA (US); Brenda J. EDWARDS, East Longmeadow, MA (US)

Correspondence Address: JOHN H. HORNICKEL, 4220 STATE ROAD, MEDINA, OH, 44256, US

(21) Appl. No.: 11/741,863

(22) Filed: Apr. 30, 2007

Related U.S. Application Data
(60) Provisional application No. 60/746,669, filed on May 8, 2006.

(51) Int. Cl. G06F 19/00

(52) U.S. Cl. 702/5

(57) ABSTRACT

A method is disclosed to create on government owned land an affordable Destination Spa with a unique personalized Experiential Life Management program. The program provides holistic tools to assist a client in seeking solutions to problems, education about mental wellness and an ever evolving life plan to make their life on earth easier to manage and enjoy. An optional spa structure is also disclosed with the combination of a stadium atmosphere and a cave-like atmosphere for different forms of experiences to be employed as a venue for the Experiential Life Management program. Developers and environmental remediation companies will now have a viable and profitable new use for vacant and decaying State-owned hospitals and other public facilities, while consumers will now have an affordable and unique family destination that has the potential to change lives.

### CLAIM OF PRIORITY

This application claims priority from U.S. Provisional Patent Application Ser. No. 60/746,669 bearing Attorney Docket Number HET001 and filed on May 8, 2006, which is incorporated by reference.

### FIELD OF THE INVENTION

This invention concerns a method of using of government owned land, especially abandoned state or local land, to develop a destination location for health, entertainment, and relaxation.

### BACKGROUND OF THE INVENTION

In today's American culture, the most amazing advances in technology, western medicine, and alternative spiritual experiences should be making our lives easier and more fulfilling. But, humans are not evolving as fast as technology and no matter how much productivity enhancements make our lives more interconnected with work, home, relatives, and friends, eliminating that disconnectedness causes a loss of unbudgeted time, formerly known as leisure. The loss of time, of control, of human relationships with others as well as with our own selves, has led to a society that is extremely unhappy and unhealthy.

At the same time, numerous small cities and rural towns have government owned land, both developed and undeveloped. Of the former, decaying former State Mental and Medical Institutions, Schools and 19th century Sanitarium sites that seem to have no hope of ever returning to viable and productive use are usually large real estate parcels. Originally chosen for their bucolic locations with spectacular views and rolling terrain, those infected with tuberculosis or adjudged to be mentally challenged, e.g., wards of the court, were thought to have a better opportunity to “get better” if they were confined in a beautiful and peaceful area with plenty of fresh air. In the late 19th and early 20th century, hundreds of these facilities were built with superior craftsmanship to look like stately mansions and dormitories; a college campus of sorts. What happened inside was not always the best medical or emotional route, but at the time, it was all that modern medicine had to offer.

The uneasy and tragic histories of these institutions make them seem a pariah to most developers because the real environmental contamination of their antiquated systems of now prohibited heating and cooling polluting products and the perception that remains, “once a mental hospital, always a mental hospital”. Unless there is a viable “flagship” idea to put on these tragic sites into a rebirth of productivity, developers see the cost of remediation vividly exceeding the return on investment. But the town owners of these sites remember them as the biggest economic engine the town may have had in the past. Many remember the employees and the patients that they grew to know and love. So not everyone sees these decrepit sites as a total, hopeless loss.

For previously undeveloped areas of government owned land, often in remotely populated areas, economies of such areas can benefit from a reason for people to travel to such areas.

### SUMMARY OF THE INVENTION

This invention solves the problems identified above by creating a wonderful reason for the rebirth of government owned lands, especially abandoned State School/Sanitarium or Medical Institutions tracts, or previously undeveloped lands by providing a unique affordable family destination that serves as a “home base” from which participants can emerge with a unique plan for healthy living.

For abandoned lands, where the original goals of many of these tragic sites were thought to be the care of the “hopelessly socially unfit but otherwise healthy wards of the state,” such sites, often near large population areas, now have the potential to become the care of the “hopefully fit and well citizens of the state”.

Whether it is one session of diagnosis and treatment or a lifetime of visits, the unique Destination Spa of the present invention changes as Americans change, and makes our lives easier to manage, appreciate, and fully enjoy.

As hard as Americans work, for such reasons as to achieve financial stability and personal satisfaction, lack of time to “take stock” of their overworked, toxic lives eats away their overall health. Americans know there are places that will help them to relax, rejuvenate and refresh, but for a very large ticket price. And when Americans do find that “perfect” place, like a so-called Destination Resort that has everything anyone could possibly want to physically and mentally reconnect, can Americans really afford it? Are their children welcome? And just what are Americans paying for that is supposed to change their lives once Americans leave that place, should Americans be able to afford it? And when Americans find this place, what is its history? Is there meaning deeper than it being a very expensive former mansion or hotel for the very rich?

The newest form of vacation for Americans, a Destination Spa with a theme or emphasis means many things to many people: developers, visitors, employees. For this invention a “Destination Spa” is defined to be “an environment that is dedicated to providing access to and educating people about the benefits of physical activity, nutritious eating, mind-body connections and therapeutic advantages of massage and body treatments.”

Certainly conventional Destination Resorts have existed, from the hot springs baths of Romans, Japanese, and Europeans to the grand hotels built by American railroads or steamship companies to encourage passenger transportation to a pretty place with good food. But the present invention differs from such historical and current Destination Resorts by (1) using previously-developed-but-currently-disfavored government lands or previously-undeveloped government lands to build a Destination Spa and (2) offering at that Destination Spa an affordable program called in this invention to be “Experiential Life Management.”

“Experiential life management” means Quantum Life Management (QLM) plus the appropriate physical facilities in one location to fulfill the precepts of QLM. “Quantum Life Management (QLM) is a life-coaching workshop-oriented program for individuals or groups established by Ms. Brenda Edwards to develop techniques and skills to lead a more fulfilling life. Further information about QLM can be found at www.quantumlm.com, which information is incorporated by reference as if fully rewritten herein.

According to published studies, people going to Destination Resorts of the modem era feel much more energetic after a visit to a Destination Resort with a theme or emphasis, are more alert, appear to have a very high ability to resolve challenges, have an increased ability to relax each evening, feel better able to handle everyday life, seem to handle business affairs better, feel more creative, have more energy when they awake in the morning, and feel an improved ability to concentrate. Upon returning home, the visitors feel more physically fit, are more confident about their cardiovascular and heart health, have more endurance, feel more agile, are more happy with their body image, and exercise more enthusiastically. Visitors also report that they feel more connected to family, friends and work associates, have a greater understanding of self, feel more cared for by family, friends and colleagues, and exude an attitude which is seen by family and friends to be a definite positive change.

Unfortunately, many of the above benefits from attending a Destination Resort come at a very expensive price, making the trip beyond the economic reach of many Americans. Moreover, they do or do not offer true forms of “mindful” life management, are or are not family friendly, and in most cases, are completely newly built resorts with no sense of historical connectedness to the area.

By contrast, the present invention is a means of offering a Destination Spa with Experiential Life Management that most Americans can afford or would feel comfortable going to, especially with family members. The present invention offers a family friendly, affordable, unique layered Experiential Life Management packages that assist in changing lives, integrated on a government-owned site that most developers would think is not worth investing.

Therefore, one aspect of the invention is a method of using currently undesired government land, comprising the steps of (a) selecting the government land, (b) constructing a Destination Spa, and (c) providing Experiential Life Management at the Destination Spa.

Another aspect of the invention is a spa structure comprising a plurality of hot spa tubs on multiple horizontal levels above ground level. These multiple hot tubs are used at the Destination Spa to assist in Experiential Life Management.

Advantages of the method of this invention will be discussed below in relation to the following drawings.

### BRIEF DESCRIPTION OF DRAWINGS

FIG. 1 is a flowchart of decision-making for a visitor choosing between a typical high end Destination Resort and an affordable Destination Spa of the present invention.

FIG. 2 is a flowchart of decision-making for a visitor who chooses the affordable Destination Spa of the present invention.

FIG. 3 continues the flowchart of FIG. 2 for the visitor who chooses to undertake Experiential Life Management during a multi-day visit to the Destination Spa.

FIG. 4 is a flowchart of decision-making for a developer contemplating location of a Destination Spa of the present invention on government owned land.

FIG. 5 continues the flowchart of FIG. 4.

FIG. 6 is a flowchart of the use of an optional water spa structure of the invention.

FIG. 7 is a depiction of the optional water spa structure of the invention.

FIG. 8 is a front, partial cross-sectional view of the optional water spa structure.

FIG. 9 is a side, partial cross-sectional view of the optional water spa structure.

### EMBODIMENTS OF THE INVENTION

Explanation of Experiential Life Management

The Quantum Life Management program is directed by founder and Master Coach Brenda J. Edwards, located at 30 Westwood Ave., East Longmeadow, Mass. The Quantum Life Management Center organizes lectures workshops, wellness days, conferences, referral services, world-wide networking and a travel service offering custom journeys of self-discovery, providing people with their own personal growth experience. QLM also publishes newsletters, books, articles and recordings.

Coach Edwards is dedicated to using a heart-centered approach while guiding clients to self-empowerment, personal growth and fulfillment of their life's dreams and goals. She offers decades of expertise, along with cutting edge techniques that encourages clients, whether individually or in groups, to take charge of their own lives and futures and to find answers to difficult questions such as “Why am I here?”, “What am I supposed to be doing?”, and “Is there more to life than this?”

Quantum Life Management (QLM) goes far beyond what is commonly thought of as “stress reduction” or spirituality-based programming. It is variety of powerful and unique supervised coaching programs that assist individuals or groups in discovering and reaching personal, social and financial goals. Based on advanced neurological and holistic concepts, Quantum Life Management can create breakthrough results in a process that optimizes health and well-being for the client.

The QLM Mission is to improve the balance and wholeness of body, mind, and spirit for individuals, groups, and families by providing cutting edge coaching and healing techniques to facilitate self discovery, balanced growth, inner peace, and healing.

The goal of this invention to place Quantum Life Management within an affordable Destination Spa with appropriate physical facilities for the visitors to realize and experience the techniques and skills of QLM in one physical location. In that respect, Experiential Life Management is a major advancement on QLM because the visitor/participant gains a real tine, real-world experience that embodies the theoretical techniques and skills that QLM assists or coaches.

Experiential Life Management (“ELM”) at a Destination Spa according to the method of the present invention is to be a source of positive, balanced growth for both client and community, providing clients with tools for increased self-awareness, self-esteem, increased fulfillment in relationships and career, reduced stress and improvement in general well being. This is done in an environment where everyone feels welcome and is encouraged to move at his/her own pace and to take control of her/his own process. ELM provides the community with economic opportunity in terms of new job creation, increased tourism dollars, center provided community services, and the positive impact of the Experiential Life Management core values and processes on its clients, employees, and service providers.

Experiential Life Management is the heart-centered core of this Destination Spa invention. It is the central focus of a Destination Resort for people who want to have a life changing experience or as the centerpiece for groups, families and individuals of any age who wish to experience many different levels of rejuvenation and relaxation in a family and corporate resort. Through personal and corporate workshops and programs guests may enjoy one-on-one intensives or group sessions, and various outdoor activities such as Ropes Courses (teambuilding obstacle courses using hanging ropes, swinging ropes, and climbing ropes), sporting activities and group walks and discussions. Programs offered include healing through equine assisted therapy, interactive art forms, herbs, nutritional cooking, gardening, physical conditioning, latest trends in spa treatments and the unique four-season aqua amenities of the Destination Spa Complex and its natural surroundings.

Helping people get in touch with the deeper parts of themselves facilitates more stress free living, connection to selves and others, a greater sense of awareness and acceptance of the joys of living and an easy tolerance for circumstances beyond their control. This brings them back to a natural state of peace, harmony, and balance, which is ultimately reflected in careers, personal relationships, health, and general well being.

One advantage of this invention that differs from all other resorts and spas that offer life coaching or life enhancement services as an optional service is that the Destination Spa can be created around the concept of Experiential Life Management as the core of the complex, with the Destination Spa being specifically designed to have ELM services creatively integrated into almost every aspect of the Destination Spa Complex of facilities.

Americans need an affordable Destination Spa on a site that deserves a rebirth to receive a unique form of personalized “mind and body” repair and education; to answer specific questions to specific issues that Americans can continue to work on at home as well as the next time Americans visit the affordable Destination Spa.

As stated above, this invention solves that problem by creating a new type of Destination Spa, on low-priced or free government owned land, and incorporates the Experiential Life Management program into the indigenous history of the chosen abandoned or undeveloped site, usually owned by a town or state.

Purpose and Activities at Destination Spa

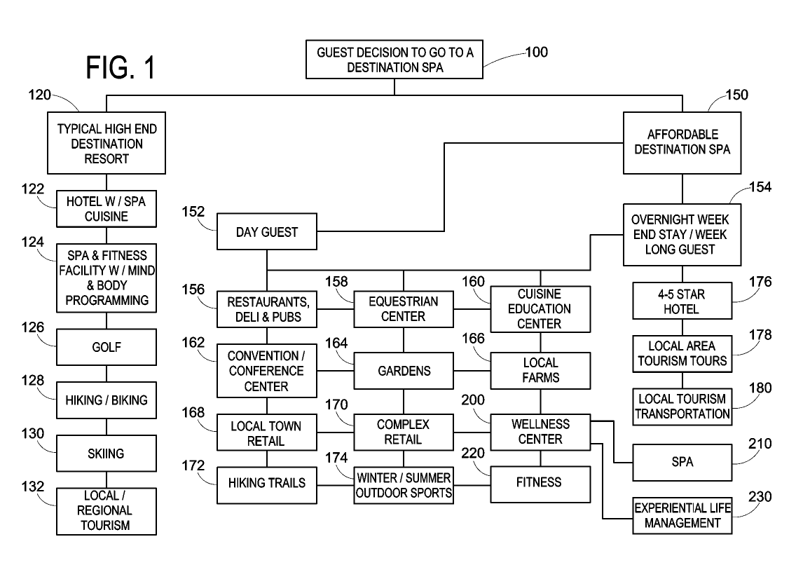

FIG. 1 shows a flowchart 100 for a guest deciding whether to spend a considerable amount of money to attend a typical high end Destination Resort 120, such as a golfing location, a beachfront location, or other location, or a Destination Spa 150 of the present invention. The resort 120 typically can be visited for a few days for the purposes of enjoying a hotel with spa cuisine 122, a spa and fitness facility 124 with mind and body programming, golf course(s) 126, hiking and biking trails 128, ski slopes 130, local and regional tourist sites nearby 132, etc.

The Destination Spa 150 of the present invention can be divided into two different events, a day trip 152 or an overnight stay 154. Most of the events at the spa 150 can be used by both types of visitors: restaurants 156, equestrian facilities 158, cuisine education center 160, conference and convention facilities 162, gardens, 164, local farms 166, local retail facilities 168, spa retail facilities 170, hiking and biking trails 172, and outdoor sports for various seasons 174.

For those visitors staying at the spa for more than one day, additional facilities and events include a hotel 176, local tourism locations 178, and local tourism transportation 180.

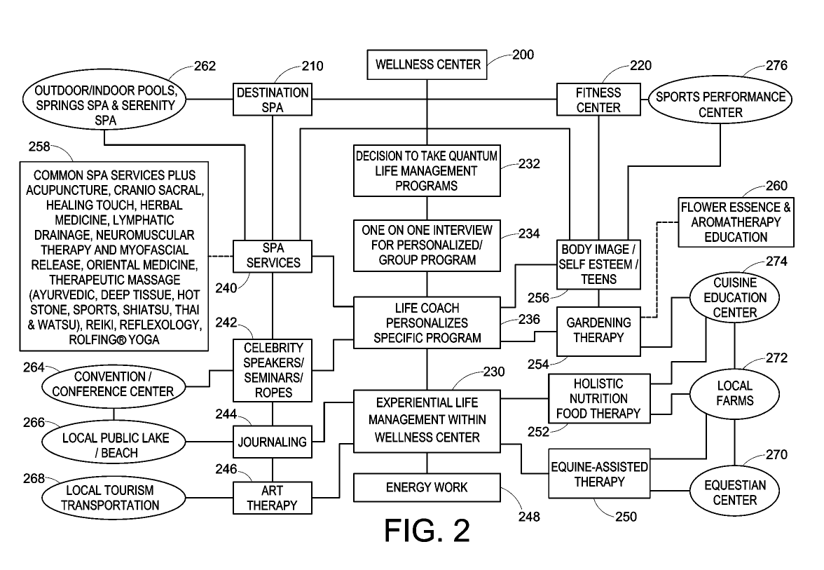

For both types of visitors, a feature of the present invention is a wellness center 200 composed of three major components, a traditional spa 210, a traditional fitness center 220, and a facility and program devoted to Experiential Life Management 230, appearing in the flowchart of FIG. 1 but also expanded in FIG. 2.

FIG. 2 elaborates on the wellness center 200 and its spa 210 for relaxation and fitness center 220 for exercise. While both the spa 210 and fitness center 220 seem traditional in structure, they are not traditional in function because both are ancillary to the function of the Experiential Life Management program 230 as the centerpiece of the reason for choosing the Destination Spa of the present invention.

Prerequisites for a visitor to the wellness center contemplating undertaking the Experiential Life Management program 230 include the decision itself 232, an interview with a professional to understand the nature of Experiential Life Management 234, and introduction to an Experiential Life Management coach 236.

Among the choices that a coach of Experiential Life Management can choose from, several are shown in FIG. 2. But this list is not exclusive or exhaustive because the science of Quantum. Life Management continues to evolve. Non-limiting examples of activities include spa services 240, celebrity speakers, seminars, and Ropes Courses 242, journaling 244, art therapy 246, energy work 248, equine-assisted therapy 250, holistic nutrition and food therapy 252, gardening therapy 254, and body image, self esteem, and teen therapy 256.

These activities can be supplemented by other services such as those holistic and medical services listed in block 258 associated with spa services 240 and flower essence and aromatherapy listed in block 260 associated with gardening therapy 254.

These activities can occur at the Destination Spa 150 or in nearby locations. Such places are neither exclusive nor exhaustive because the business of recreation and therapy continues to evolve. Non-limiting examples of places where the Experiential Life Management program can occur are indoor and outdoor spa facilities 262, a conference or convention center 264, local waterfront 266, local tourist sites 268, equestrian center 270, local farms 272, cuisine education center 274, and sports performance center 276. All of these facilities are either on the site of the Destination Spa or locally adjacent thereto.

FIG. 2 shows the linkage between the various activities 240-260 with the various places 262-276, all within the operations of the Experiential Life Management program 230 of the wellness center 200.

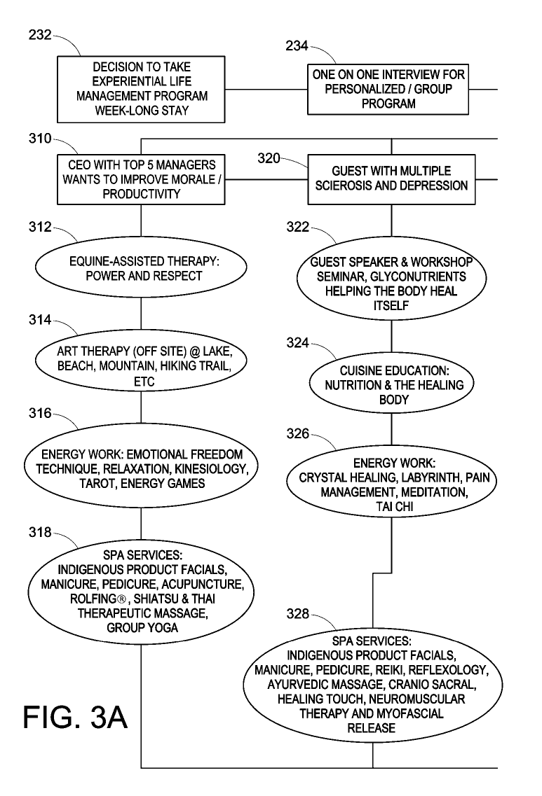

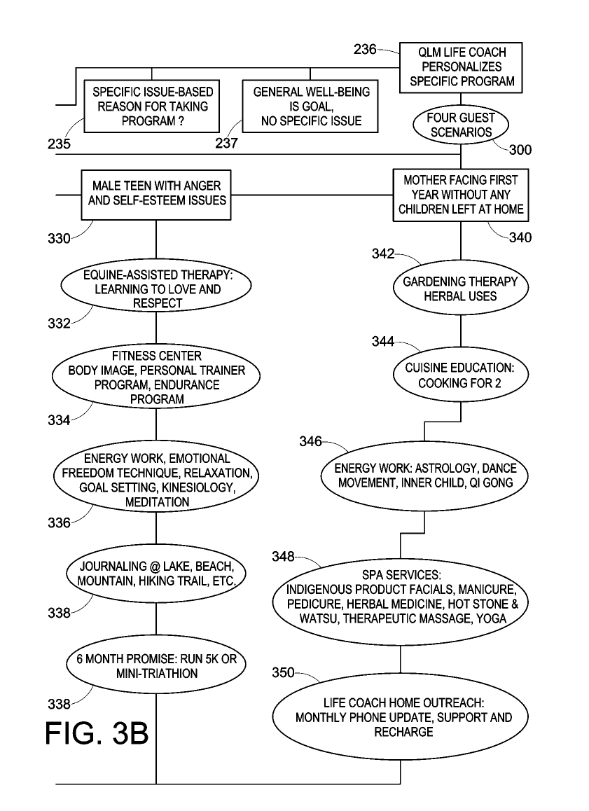

FIG. 3 shows a flowchart of how different visitors might engage in different Experiential Life Management programs, starting with the original decision 232, the interview 234, and the establishment of a coach 236. Two key questions in the interview 234 are whether the visitor has specific reasons 235 for undertaking Experiential Life Management or a general interest 237 in well-being.

FIG. 3 shows four different scenarios 300 that are neither exclusive nor exhaustive because each visitor presents unique issues for those coaching Experiential Life Management.

Scenario 310 is a Chief Executive Officer of a company needing to improve morale and productivity within her/his organization. The group program for the top five Managers of his/her organization might be equine-assisted therapy 312 to inspire power and respect, an therapy 314 to improve attention to detail in a relaxed environment, energy work 316 to increase personal enthusiasm and group cohesiveness, and indigenous spa services 318 to provide total body relaxation and restoration for the group. The CEO would be encouraged to take part in the group program as he/she is head of the organization “team” and would benefit on a personal level as well.

Scenario 320 is a person with multiple sclerosis and depression. The program for that person might be a speaker and workshop on body health 322, cuisine education 324, energy work 326, and indigenous spa services 328.

Scenario 330 is a young male with anger and self-esteem issues. The program for that youthful person might be equine assisted therapy 332, the fitness center 334, energy work 336, journaling 338, and a future goal of running in a race 339 once he left the complex.

Scenario 340 is a mother whose last child has moved away from home. The program for that “empty nester” might be gardening therapy 342, cuisine education for fewer people at home 344, energy work 346, and indigenous spa services 348.

Preferable to the Experiential Life Management 230 is the continuation of coaching even after the visitor has left the Destination Spa 150. Block 350 shows home outreach by the life coach established at step 236 to continue coaching the individuals who have visited the Destination Spa 150 and undertaken Experiential Life Management 230.

It is entirely possible for those being coached to return in succeeding visits to the Destination Spa 150 to continue with the appropriate scenario 300 or to begin a different scenario 300 according to different life issues or a desire to experience additional life management programs.

Selection of Location of Destination Spa

The people ultimately own government land. Some of that land has never been developed, but usually in a remote or thinly populated location, such as in mountainous, forested lands owned by the Bureau of Land Management or the U.S. Forest Service; rolling terrain such as Native American reservations; etc.

But most of the government owned lands suitable for the present invention are near large population centers but currently disfavored land tracts.

Land that is environmentally contaminated enough to make it almost worthless in current condition is extremely appealing to companies and corporations that remediate so-called “Brownfield” sites. Those companies can take advantage of state and Federal remediation and economic finding sources; as long as there is something viable to go on the site once it is cleaned. If a remediation company can not find a profitable theme for the site, they will not be qualified to apply for economic finding sources and just cleaning the land/buildings and hoping to sell parcels off for residential or commercial profit out of their own pockets usually will not begin to cover the extraordinary cost of clean up. There must be a viable reason for economic development for the site and since most of the abandoned State School or Sanitarium sites in America are out in the country but nonetheless near large population centers, the chosen economic development must be a destination and must be unique.

“Environmental clean up” companies are sometimes associated with real estate development companies who become the “master developer” of the project. But the project on the contaminated land must reach a few important benchnarks.

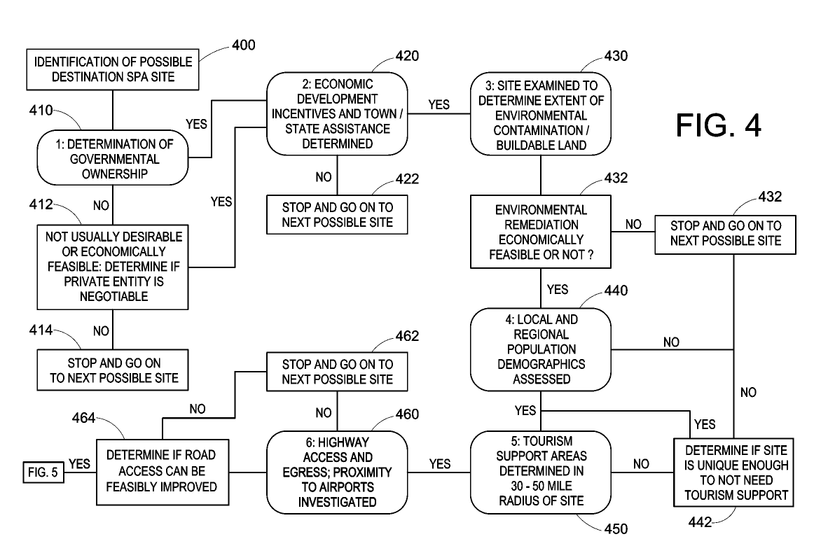

FIG. 4 shows a flowchart of those benchmarks and decision points. The master developer must first identify possible sites for the Destination Spa 400.

First, it must be determined 410 whether a site is owned by a governmental entity. Specifically, it must be learned whether the land is owned by a town, city, state or other quasi-governmental entity. If no, then only if private ownership is subject to eminent domain will the land acquisition cost be economically feasible, as seen in block 412. If not, then another site needs to be found, 414. If either the land is publicly owned or can be subject to eminent domain proceedings, then the second step of seeking incentives of economic development can begin, as seen in block 420.

Ownership by a governmental entity usually means the highest and best use of the property and future tax base is the goal, not a quick profit on land. Second, working with a governmental entity also adds leverage to special tax incremental financing, Brownfield funds, historic monies and other economic incentive finding sources. The availability of these economic incentives will be investigated as well as the willingness of the town and the state to assist. If not, then one must move to another possible site, as seen in block 422. But if yes, the environmental step 430 is undertaken.

Step 430 begins with the site being walked and examined by environmental remediation representatives to determine if the contamination outweighs the possible future return on investment. If the clean up is extraordinarily extensive, the site may be rejected, block 432. Generally, the site should be also more than 20 acres and 75% “buildable” as that term is used in zoning and real estate development. One is not likely to build on water, wetlands, etc.

If step 430 is met, the next step 440 is research of local and regional population demographics and the extent of upward growth trends as future consumers of the site and service workers and employees. Generally, for economic viability about 100,000 people living within 15 minutes of site is a lowest possibility for supportable demographics. If not, then the uniqueness of the site is taken into consideration, as seen in block 442.

If step 440 is met, then the extent of tourism sites or points of interest within the regional area is considered, step 450. Generally the practical range of daily tourism sites is about a 30-50 mile radius. If not sufficient, then the uniqueness of the site 442 is also taken into consideration.

If step 450 is met, then highway access will be analyzed in step 460 for ease of access and egress to and from the site via major highways and one major airport. The site does not have to be directly off a major highway, as are typical “flag” hotel entities, but should be a reasonably easy drive from a secondary highway. If not, then one moves to the next site, as indicated in block 462. If yes, then one should determine if road access to the site needs improvement and is feasible, as seen in block 464.

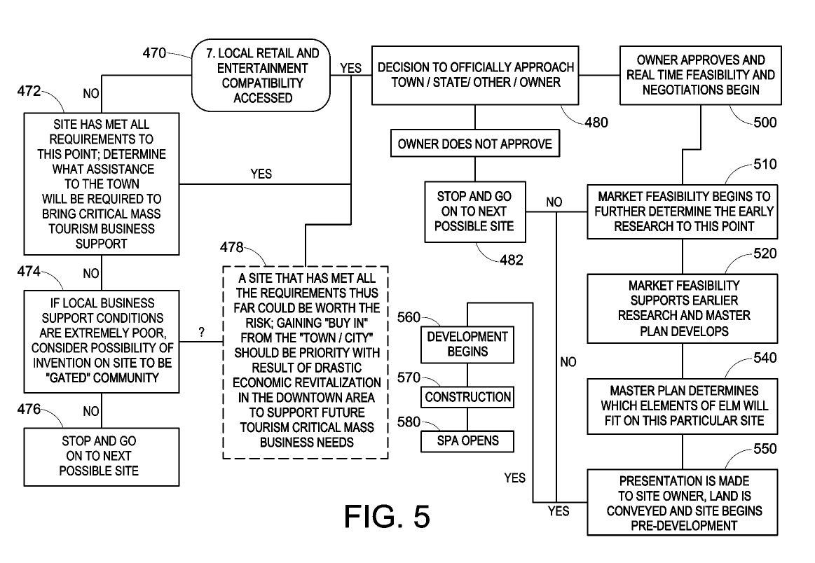

The flowchart begun in FIG. 4 now proceeds to FIG. 5 and the next step, determination in step 470 of local town or city retail and entertainment zones will be accessed for compatibility with the future health and wellness tourism destination.

If all of these requirements have been met, the site may be appropriate for economic development but the following factors should be taken into consideration.

What assistance will be needed to help local government officials understand the need for critical mass tourism business support, block 472. If not enough exists, perhaps the Destination Spa should become a limited access facility, as seen in block 474. If enough critical mass exists, because of an understanding of the need for economic revitalization, as seen in block 476, then a decision can be made in step 480 to officially approach the necessary participants to begin the approval process of development by submitting documents and being placed on agendas of meetings conducted by public agencies and governmental bodies.

If the land owner does not approve, then one must move to another possible site, as explained in block 482. But if the land owner is interested, then feasibility of public development begins, as seen in step 500.

Market feasibility 510 first augments the site selection activities 400-482 to date. If this more extensive market feasibility does not yield economically viable answers, then one must move to another possible site, also seen in block 482. But if market feasibility 510 confirms site selection activities 480-482, then a master plan 520 is written, especially in step 540 showing which of the various physical facilities of ELM suitable for the destination spa, as explained with reference to FIGS. 1-3, are appropriate for the particular land under planning. The next step is to present the customized master plan, step 560, to the land owner, the various governmental entities, the various members of the interested public, etc. If approved, then authorized development 560 of the Destination Spa can begin with construction 570 following and the spa eventually opens 580.

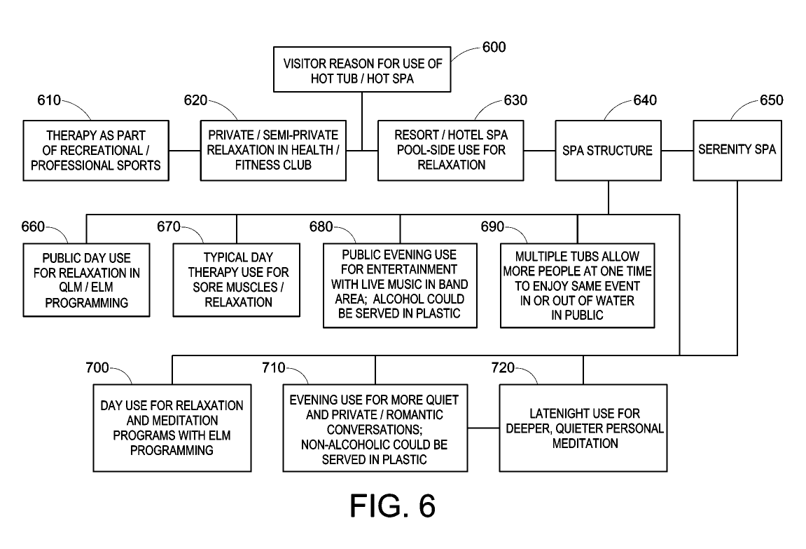

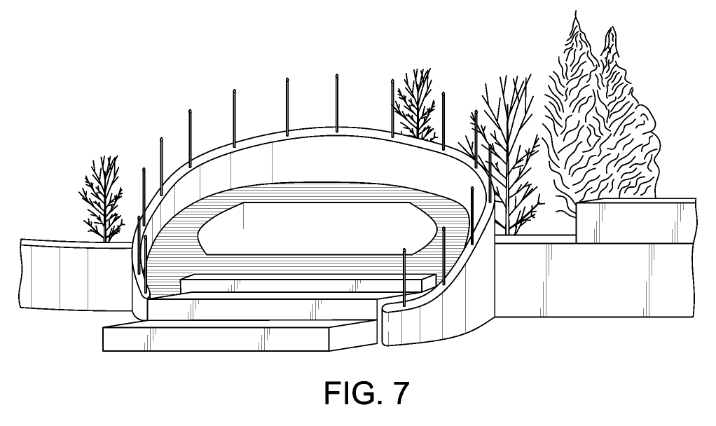

An optional aspect of this invention is a spa structure that can serve the public in typical fashion and also serve in a completely new capacity of the present invention. FIG. 6 is a flowchart that shows a visitor's reason for using a hot tub spa 600. Depending on the location and reason for visit, hot tubs are currently used for therapy as part of recreational or professional sports 610, private or semi-private relaxation in a health or fitness club 620, or for relaxation pool-side at a resort or hotel spa 630. Both the assembly spa structure 640 and the serenity spa 650 not only provide all of the advantages above mentioned, but also, both spas 640 and 650 go a step further to offer a hot tub, or several of them, in a stadium style configuration as shown in the depiction of FIG. 7, as a vehicle for entertainment, ELM programming (232 in FIG. 3), and other group assembly activities.

FIG. 6 further explains choices of use, such as the use of this assembly hot tub structure 640 for public day uses for relaxation in ELM programming 660, typical day therapy used for sore muscles 670, public evening use for entertainment with live music in the band shell and dance floor area out front, tables and chairs to the sides, with the possibility of alcohol service 680 and in all, these multiple tubs allow more people at one time to enjoy the same group therapy event or entertainment event in or out of the water 690.

The Serenity Spa 650, located off the back of the main structure offers day use for relaxation and meditation programs with ELM 700, evening use for more quiet and private conversations and non-alcoholic refreshments 710 and late night use for deeper more personal meditation 720.

As mentioned previously, FIG. 7 is an artist's rendering of the main multi-level structure 640 that resembles a stadium-style seating set up, but instead of actual seats, there are hot tubs that could hold 10 or more people per tub. In FIG. 7, the ground floor areas off to the left and right of the structure can be for tables and chairs for those guests who choose not to get in a hot tub and the ground floor area directly in front of the structure can be for those who want to dance or stand while all guests have the ability to watch and enjoy a band or acoustic group playing live music. This is the group aspect of “entertainment” that other hot tubs areas do not have.

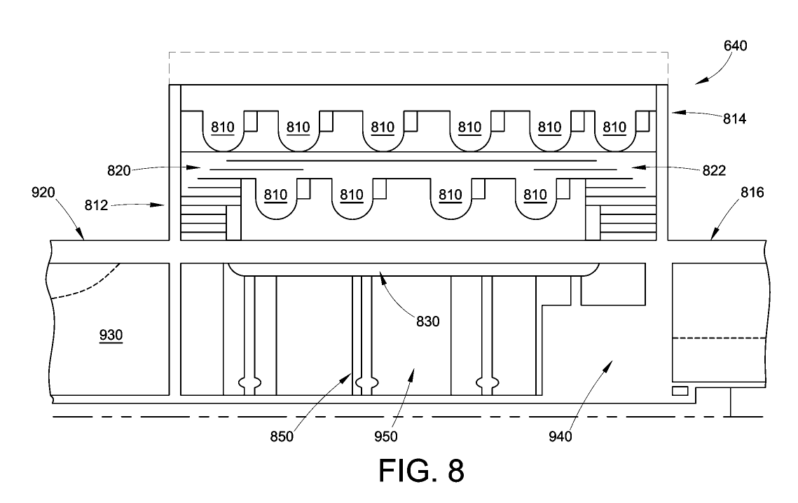

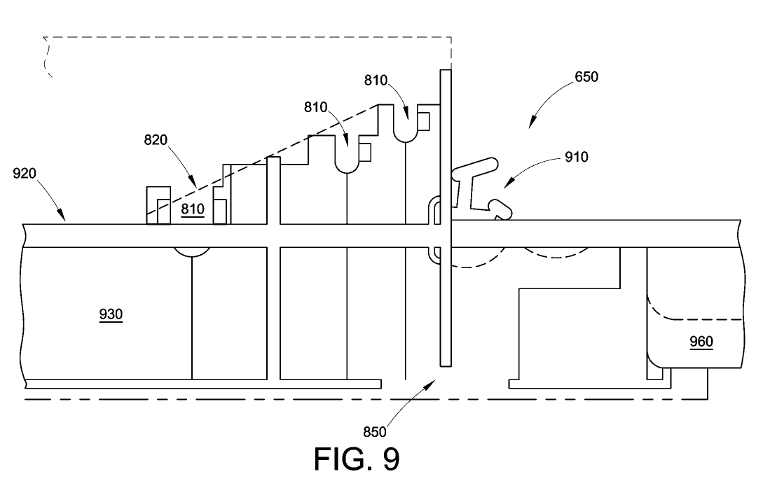

Off the back of this large structure is the Serenity Spa 650 that shares the plumbing and maintenance area underneath of the main structure, as shown in FIGS. 8 and 9.

In addition to being useful in this invention, these hot tub spas 640 and 650 as a unitary structure can be utilized at any wellness center or spa location of any “flag” or “name” hospitality business because the combination of spas 640 and 650 is a multiple hot tub structure that offers the typical therapeutic programming within a relaxing environment of hot tubs but also offers this set up for entertainment purposes.

FIG. 7 further depicts the mechanics of the spa structure which can be half-moon shaped with 6 hot tubs in a semi circle on the top level and 4 hot tubs in the middle level with a larger, longer “community” tub, serviced by a pool bar on the ground floor.

As seen in FIG. 8, for use in a group therapy program, the hot tub spas 810 (10 of them shown in cross-section on two levels 812 and 814 above ground level 816) could each measure 10 ft in diameter to accommodate a number of people in each tub 810 in assembly for entertainment, Experiential Life Management, or other activities.

Levels 812 and 814 and the plurality of hot tub spas can be served by two sets of steps 820 and 822 leading from bottom to top.

The “community” long hot tub spa 830 on ground level 816 could be larger, e.g., about 15 feet in width to hold a larger collection of people comfortably, where they will be closest to the entertainment, Experiential Life Management, or other activities. The specific bottom layer 840 would be complementary to typical “pool bars” found in many resort locations.

This entire structure 640 also can share plumbing 850 with a secondary aqua amenity, such as the Serenity Spa 650.

As seen in FIG. 9, this quieter and larger spa 650, optionally created in a “cave-like” quality or grotto setting from indigenous rocks and boulders (shown as “rock formations” 910) of the site area during excavation of the Destination Spa 150 or the spas 640 and 650, can be located off the lower back of the stadium-style structure 640 where the atmosphere is calmer for reflection, relaxation and meditation 700, 710, 720, as discussed with reference to the flowchart of FIG. 6.

As shown in FIGS. 8 and 9, the lower halves of both of the structures 640 and 650 are under a common concrete stab floor 920 and offer a maintenance room 930 where both multiple spa structures 640 and 650 and their filtration and compressor systems 940 can be serviced. This area 930 could also offer storage, access to the drainage system 950 and the availability to add insulation to the bottoms of each of the 10 or more individual hot tub spas 810 as a means of assisting in the sustainable heating of the tub water.

FIG. 8 and FIG. 9 also show this multilevel structure has the ability to share plumbing and drainage 850 with other aqua amenities such as a swimming pool 960 of any acceptable size, that any hospitality or wellness center currently has or could have.

Alternatively, spas 640 and/or 650 could stand alone or tie into existing plumbing and drainage 850 of any wellness center, spa or hotel amenities, including the Destination Spa 150 of the present invention.

Usefulness of the Invention

The method of this invention utilizes a hotel; small to large convention center; cuisine education center; wellness center with state of the art spa and treatment rooms, fitness area and Experiential Life Management treatment rooms; equestrian center with dressage and showing, hunter/jumper, instruction and pleasure trail riding; local and/or regional historical museum; arts, crafts and retail indigenous to the region and state; medical and regular office space for complementary businesses and possible spa living residential areas. Whenever possible, remediated buildings on the chosen site should be reclaimed for the highest and best possible use; part of the positive public relations foundation and ‘community buy-in” is due to the positive reuse of historic old buildings that have a place in the town's history. Some of the buildings worth saving could have a negative history, but the type of history and decision of what exact portion of the destination spa complex will locate within, can determine whether the building stays or goes, using the method of this invention.

Experiential Life Management utilizes the hotel and restaurants for guests; ballroom and meeting space for seminars, speakers and presentations; the Equestrian Center for Equine-Assisted Therapy; Progressive Gardens for Healing Therapy; talent in the area for Art Therapy; Cuisine Education Center for Nutritional Therapy; the Spa for traditional as well as the newest trends in spa services, local off campus farms for seasonal plant/food/festival programming, nearby bodies of water, hiking trails for nature walks, drawing, journaling, photography, indigenous plant gathering and meditation. The ELM clients would also require the services of local transportation to natural area amenities and programming that requires day trip traveling to other tourism sites areas of the chosen abandoned site. Experiential Life Management is truly integrated with almost every aspect of the complex, enhancing the experience of every guest and increasing the profit potential of the entire Destination Spa.

It should be noted that life coaches and the Experiential Life Management programs are not a form of medical therapy, psychoanalysis, psychology, or other medical modality. Experiential Life Management coaches do not diagnose or treat physical, emotional or mental conditions. They do lead clients through a process of self-discovery providing the tools and resources to facilitate a client in reaching his/her personal and professional goals.

Based on advanced neurological and holistic concepts, Experiential Life Management creates breakthrough results in a process that optimizes health and well-being for the client.

Guests that participate in the ELM program receive a solution to an issue or path to a solution that they would not normally find at a typical resort and everyone's package is personalized. ELM at the Destination Spa of the present invention could change lives. The method of this invention is also affordable because it is built on essentially “free” formerly government-owned land and makes use of tax incentive and economic development funding for environmental cleanup and infrastructure.

The method of this invention also makes use of undesired, abandoned, environmentally contaminated land that seems to have no affordable use to the typical developer.

This business method differs from conventional life coaching because that activity usually happens in a classroom or quiet setting. Once the session is over, the client leaves. The Destination Spa of this invention has the following differences: it should have an overnight stay, it should have spa and fitness facilities and programming, and it should have spa specific cuisine and Mind/Body programming. ELM offers many unique steps beyond the typical Mind/Body programming of typical Destination Resorts. ELM is integrated into every physical aspect of the method of this invention, increasing the profitability of all the other businesses that ELM touches. The actual tools used in the ELM program can be common to life coaching as it is currently known today and incorporate virtually any new healing modality that emerges in the future. Those tools include, but are not limited to, Acupuncture, Aromatherapy Education, Astrology, Cranio Sacral, Crystal Healing, Dance Movement, Emotional Freedom Technique, Energy Games, Enhancing Intuition, Flower Essence, Healing Touch, Herbal Medicine, Homeopathy, Hypnotherapy, Inner Child, Kinesiology, Lymphatic Drainage, Neuromuscular Therapy, Myofascial Release, Oriental Medicine, Pain Management, Past Life Regression, Reiki, Reflexology, Rolfing®, Meditation, Relaxation, Therapeutic Massage (Ayurvedic, Deep Tissue, Hot Stone, Sports, Shiatsu, Thai & Watsu), Tai chi, Tarot, Qi Gong, Yoga, etc.

The choice of sites for the method of this invention is unexpected to someone in real estate development or economic development because most see former mental institutions and sanitariums as “sick” places and can not get past the stigma or perception of the area being a home for the “feeble minded” or deathly ill. Because of this fact, most developers would not touch these large environmentally contaminated sites because in order to clean them up, one should have something large enough economically to pay back the cost of remediation.

Finally, and optionally, the Destination Spa can use a unique multiply-purpose hot tub spa structure that on one side accommodates multiple-level soaking and viewing entertainment in a stadium-style atmosphere, while on the other side a secluded and serene soaking in a “grotto” atmosphere. With the uniqueness of this optional structure at the Destination Spa, Experiential Life Management can benefit by providing an on-site experience that is unavailable at other accommodations.

The invention is not limited to the above embodiments. The claims follow.

What is claimed is:

1. A method of using currently undesired government land, comprising the steps of:
(a) selecting the government land;
(b) constructing a Destination Spa;
(c) providing Experiential Life Management at the Destination Spa.

2. The method of claim 1, wherein Experiential Life Management comprises Quantum Life Management and appropriate physical facilities at the Destination Spa to fulfill precepts of Quantum Life Management.

3. The method of claim 1, wherein the Destination Spa has a theme or emphasis called Quantum Life Management.

4. The method of claim 1, Experiential Life Management comprises packages of family friendly, affordable activities on the government land at the Destination Spa, in order to assist in changing lives.

5. The method of claim 4, wherein the changed lives include one or more of (a) being more alert, (b) appearing to have a very high ability to resolve challenges, (c) having an increased ability to relax each evening, (d) feeling better able to handle everyday life, (e) seeming to handle business affairs better, (f) feeling more creative, (g) having more energy when awaking in the morning, and (h) feeling an improved ability to concentrate.

6. The method of claim 3, wherein Quantum Life Management has a mission to improve balance and wholeness of body, mind, and spirit for individuals, groups, and families by providing cutting edge coaching and healing techniques to facilitate self discovery, balanced growth, inner peace, and healing.

7. The method of claim 1, wherein the Experiential Life Management at the Destination Spa provides a source of positive, balanced growth for both client and community, providing clients with tools for increased self-awareness, self-esteem, increased fulfillment in relationships and career, reduced stress and improvement in general well being, and
wherein the Destination Spa provides an environment where everyone feels welcome and is encouraged to move at his/her own pace and to take control of her/his own process.

8. The method of claim 1, wherein the Experiential Life Management at the Destination Spa can occur in either a day trip or an overnight stay, and
wherein events at the Destination Spa are selected from the group consisting of restaurants, equestrian facilities, cuisine education, conference rooms, gardens, local farms, local retail stores, spa retail facilities, hiking and biking trails, outdoor sports facilities, and combinations thereof.

9. The method of claim 1, wherein the Destination Spa includes a wellness center comprising a traditional spa, a traditional fitness center, and a facility devoted to Experiential Life Management.

10. The method of claim 1, wherein Experiential Life Management includes
(a) an interview with a professional to understand Experiential Life Management,
(b) an introduction to an Experiential Life Management coach, and
(c) selections by the coach of choices of Quantum Life Management from the group consisting of spa services, celebrity speakers, seminars, and ropes courses, journaling, art therapy, energy work, equine-assisted therapy, holistic nutrition and food therapy, gardening therapy, and body image, self esteem, and teen therapy, and combinations thereof.

11. The method of claim 1, wherein selecting the government land includes
(a) determining whether a site is owned by a governmental entity,
(b) determining by environmental remediation representatives if contamination outweighs future return on investment,
(c) researching local and regional population demographics and extent of upward growth trends of the site for accessibility by consumers and employees,
(d) considering an extent of tourism points of interest within the regional area near the site,
(e) if neither (c) nor (d) are promising, considering the uniqueness of the site,
(f) analyzing highway access for ease of access and egress to and from the site via major highways and one major airport,
(g) determining local town or city retail and entertainment zones for compatibility with a future health and wellness tourism destination,
(h) considering extent of local government support,
(i) considering level of land owner interest,
(j) studying market feasibility,
(j) writing a master plan, and
(k) gaining approvals of the master plan.

12. A spa structure, comprising: a plurality of hot spa tubs on multiple horizontal levels above ground level.

13. The spa structure of claim 12, wherein the plurality of hot spa tubs includes an assembly spa structure and a serenity spa.

14. The spa structure of claim 13, wherein the assembly spa structure has a stadium style configuration of multiple levels.

15. The spa structure of claim 14, wherein the assembly spa structure includes a dance floor area in the hot spa tubs and tables and chairs to the sides of the hot spa tubs.

16. The spa structure of claim 13, wherein the serenity spa is located back of the assembly spa structure.

17. The spa structure of claim 13, wherein the assembly spa structure and the serenity spa share plumbing and a maintenance area enclosing filtration, compressor, and drainage systems.

18. The spa structure of claim 13, wherein the assembly spa structure has a half-moon shape, six hot tubs in a semi circle on the top level, 4 hot tubs in the middle level, and a larger, longer community tub on the ground floor.

19. The spa structure of claim 13, wherein the serenity spa also includes a grotto setting.

20. The spa structure of claim 12, wherein the spa structure is part of a Destination Spa.
